(19) United States
(12) Patent Application Publication
(10) Pub. No.: US 2007/0186696 A1
(43) Pub. Date: Aug. 16, 2007

(54) Self-Wetting Aerosol Particulate Wet Collector Apparatus

(76) Inventors: Timothy Allen Pletcher, Eastampton, NJ (US); Christopher Just Poux, Trenton, NJ (US); Bryce Kittinger Campbell, Philadelphia, PA (US)

Correspondence Address: PATENT DOCKET ADMINISTRATOR;LOWENSTEIN SANDLER P.C., 65 LIVINGSTON AVENUE, ROSELAND, NJ, 07068, US

(21) Appl. No.: 11/681,578

(22) Filed: Mar. 2, 2007

Related U.S. Application Data
(63) Continuation-in-part of application No. 11/140,124, filed on May 27, 2005.
(63) Continuation-in-part of application No. 10/603,119, filed on Jun. 24, 2003, now Pat. No. 7,062,982.
(60) Provisional application No. 60/574,803, filed on May 27, 2004.
(60) Provisional application No. 60/659,362, filed on Mar. 7, 2005.
(60) Provisional application No. 60/390,974, filed on Jun. 24, 2002.
(60) Provisional application No. 60/446,323, filed on Feb. 10, 2003.

(51) Int. Cl. G01N 1/04

(52) U.S. Cl. 73/864.71

(57) ABSTRACT

The present invention provides a self-wetting apparatus for the collection or collection and concentration of particulate matter, such as pathogen particles and aerosol particles, from air. The present invention also provides methods of producing and using the self-wetting apparatus.

### CROSS-REFERENCE TO RELATED PATENTS AND PATENT APPLICATIONS

This application is a continuation-in-part of U.S. patent application Ser. No. 11/140,124, filed May 27, 2005 (entitled, “Method and Apparatus for Airborne Particle Collection”), which claims the priority benefit of U.S. Provisional Application Ser. No. 60/574,803, filed May 27, 2004 (entitled, “Electrostatic Particle Collection System”), U.S. Provisional Application Ser. No. 60/659,362, filed Mar. 7, 2005 (entitled, “Spinning Disc Electrostatic Collection System”), and which is a continuation-in-part of U.S. patent application Ser. No. 10/603,119, filed Jun. 24, 2003, now U.S. Pat. No. 7,062,982 (entitled “Method And Apparatus For Concentrated Airborne Particle Collection”), which claims the priority benefit of U.S. Provisional Application Ser. No. 60/390,974, filed Jun. 24, 2002 (entitled, “Ultra-High Concentrating Bio-Aerosol Collector”) and U.S. Provisional Application Ser. No. 60/446,323, filed Feb. 10, 2003 (entitled, “Corona-Based Bio-Aerosol Collector”). All these applications are herein incorporated by reference in their entireties.

### STATEMENT REGARDING FEDERALLY SPONSORED RESEARCH OF DEVELOPMENT

The U.S. Government has a paid-up license in this invention and the right in limited circumstances to require the patent owner to license others on reasonable terms as provided for by the terms of Contract No. W911SR-04-C-0025 awarded by the U.S. Amry Research, Development and Engineering Command Acquisition Center (RDECOM ACQ. CTR.)-W91SR, Edgewood Contracting Division, Aberdeen Proving Ground, Maryland.

### FIELD OF INVENTION

The present invention relates to devices for the collection or collection and concentration of particulate matter, such as pathogen particles and aerosol particles, from air.

### BACKGROUND OF THE INVENTION

The threat of biological and chemical warfare agents is one of the major worries in today's global environment. Development of early warning systems is of paramount interest to government agencies around the globe. The major problem is the need to collect and concentrate airborne particulates. Airborne particulate matter is solid or liquid materials that can be aerosolized and remain suspended in air. This can be any type of material. The key attribute of any material to remain airborne is the particle size of the material. The particle size of such material can vary from about 10 nm to about 10 μm in diameter. The captured material to be detected can comprise bio-threat material, such as bacterial spores, cells, viruses, bio-toxins, and the like, which are living organisms or a substance produced by living organisms (e.g., ricin and botulinum toxin). The particle size of the bio-threat material can vary in size, for example, between about 1 μm to about 10 μm particle diameter. The captured material also can comprise material, such as molecules, atoms, particles, substances and the like, that are not produced by living organisms (e.g., hydrogen cyanide).

Thus, there is an increasing demand for air sampling systems for military, private or individual use that are capable of collecting airborne particulate matter. While current air sampling systems have been proven to function reliably, they are often quite large and thus, not only consume a great deal of power, but also produce a lot of noise. These systems also tend to produce very large liquid samples, analyses of which can take several days or even weeks. Thus, current air sampling systems are not practical for private or individual use, or for environments or circumstances in which analysis of an air sample must be performed quickly.

Therefore, there is a need in the art for a compact, high-efficiency aerosol collector that can collect airborne particulate matter and produce a relatively small volume of liquid sample for expedited analysis.

### SUMMARY OF THE INVENTION

In one aspect, the present invention relates to an apparatus for collecting airborne particles from air comprising a material with a volume resistivity less than about 10 Mohm-cm, wherein the apparatus is adapted for receiving a liquid.

The present invention also relates to an apparatus for collecting airborne particles from air comprising a hollow tube adapted for receiving a liquid through an interior volume of the hollow tube and for delivering that liquid to an outer surface of the hollow tube, wherein the hollow tube comprises a material with a volume resistivity less than about 10 Mohm-cm.

The present invention further relates to an apparatus for collecting airborne particles from air comprising:
a) a hollow tube adapted for receiving a liquid through an interior volume of the hollow tube and for delivering that liquid to an outer surface of the hollow tube; and
b) a collection surface disposed on the outer surface of the hollow tube and adapted for collecting the airborne particles from the air, wherein the collection surface comprises a material with a volume resistivity less than about 10 Mohm-cm.

In another aspect, the present invention relates to a method for collecting airborne particles from air, said method comprising the steps of:
a) providing an air sample;
b) directing the air sample toward a collection apparatus of the present invention; and
c) initiating operation of the collection apparatus,
   wherein the airborne particles from the air are collected in a single stage.

### BRIEF DESCRIPTION OF THE DRAWINGS

The present invention will be more readily understood from the detailed description of exemplary embodiments presented below considered in conjunction with the attached drawings, of which:

FIG. 1 is a cut away view of one embodiment of an airborne particle collection apparatus according to the present invention;

FIG. 2 is an exploded view of the airborne particle collection apparatus illustrated in FIG. 1;

FIG. 3 is a top view of the cyclone array illustrated in FIG. 1;

FIG. 4 is a top view of the vortex breaker section illustrated in FIG. 1;

FIG. 5 is an exploded view of the capture section illustrated in FIG. 1;

FIG. 6 is a schematic illustration of corona charging section adapted for use with the capture section illustrated in FIGS. 1 and 5;

FIG. 7 is a second embodiment of a capture section and corona charging section;

FIG. 8 is a second embodiment of a collection apparatus according to the present invention;

FIG. 9 is a schematic illustration of a third embodiment of a capture section according to the present invention;

FIG. 10A is a plan view of a third embodiment of a collection apparatus according to the present invention;

FIG. 10B is a cut away view of the collection apparatus illustrated in FIG. 10A;

FIG. 11 is a cut away view of a fourth embodiment of a collection apparatus according to the present invention;

FIG. 12 is a schematic diagram illustrating a fifth embodiment of a particle collection system for depositing aerosol particles into a liquid, according to the present invention;

FIGS. 13A and 13B are schematic diagrams illustrating a typical pore of the particle collection system of FIG. 12;

FIG. 14 is a schematic diagram illustrating a sixth embodiment of a particle collection system for depositing aerosol particles into a liquid, according to the present invention;

FIG. 15 is an isometric view illustrating a seventh embodiment of a particle collection system for depositing aerosol particles into a liquid, according to the present invention;

FIG. 16A is an schematic diagram illustrating an embodiment of a particle collection apparatus for depositing aerosol particles into a liquid, according to the present invention.

FIG. 16B is a plan view of an embodiment of a collection apparatus according to the present invention; and

FIG. 16C is a plan view of an embodiment of a collection apparatus according to the present invention.

To facilitate understanding, identical reference numerals have been used, where possible, to designate identical elements that are common to the figures.

### DETAILED DESCRIPTION OF THE INVENTION

Embodiments of the invention generally provide a compact, lightweight, low power and low noise device capable of collecting respirable airborne particles and focusing them into a small liquid volume. In some embodiments, the device is capable of achieving a particle concentration in the range of approximately 1 to 10 microns (μm), and can achieve sampling rates of up to approximately 1000 liters per minute (lpm). Embodiments of the device of the present invention also can be use for air purification. For example, the device of the present invention can be part of an air handling system that removes airborne particulate matter from air that passes through it.

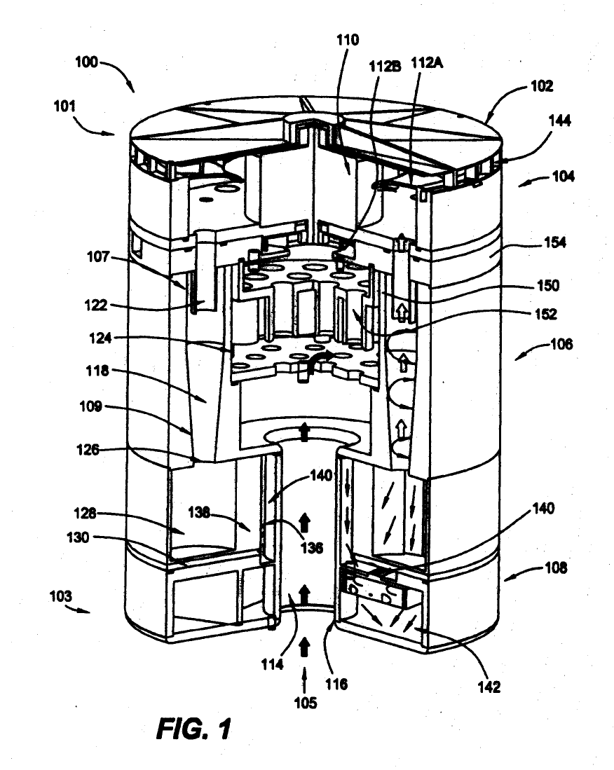

FIG. 1 is a cut away view of one embodiment of a particle collection apparatus 100 according to the present invention. In the embodiment illustrated, the apparatus 100 is constructed in a substantially cylindrical shape; however, those skilled in the art will appreciate that embodiments of the invention may be configured in any number of alternate forms and shapes without departing from the scope of the invention. The apparatus 100 comprises a housing 102, within which is contained an air intake assembly 104, a sample separation section 106, and a particle capture zone 108.

The air intake assembly 104 is adapted to draw air flow into the collection apparatus 100 and comprises a motor 110, first and second fans 112A, 112B, and an air duct 114. The first fan 112A is disposed proximate a first end 101 of the collection apparatus 100 and is coupled to the fan motor 110. The optional second fan 112B is positioned inward of the first fan 112A along a longitudinal axis of the apparatus 100, and in one embodiment, the second fan 112B is smaller than the first fan 112A. The air duct 114 begins at an aperture 116 in the second end 103 of the apparatus 100 and extends at least partially therethrough to provide an inlet path for the air that is drawn in by the fans 112A, 112B when in operation. In one embodiment, the duct 114 is disposed through the center 105 of the housing 102. Optionally, the air intake assembly 104 may further comprise an impactor 150 positioned between the duct 114 and the fans 112A, 112B and adapted to act as a pre-filter. That is, the impactor 150 includes a plurality of tubes or channels 152 for filtering large particles out of the primary flow as it is drawn into the apparatus 100.

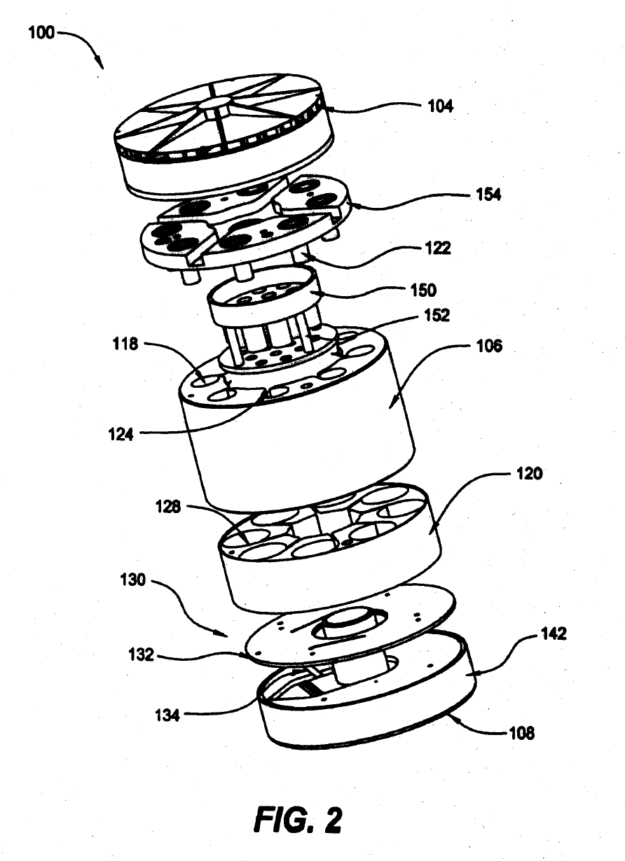

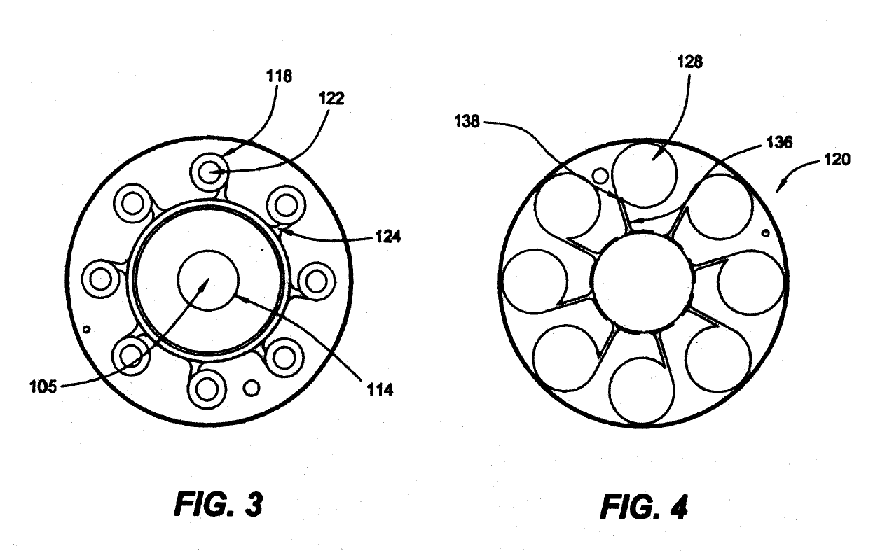

The sample separation section 106 comprises a substantially circular array of cyclones 118 positioned radially outward of the center 105 of the apparatus 100 (i.e., in the embodiment illustrated in FIG. 1, radially outward of the air duct 114) and a vortex breaker 120 (shown in FIGS. 2 and 4). FIG. 3 is a top view of the cyclone array illustrated in FIG. 1. Although FIG. 3 depicts an array of eight cyclones 118, those skilled in the art will appreciate that a greater or lesser number of cyclones 118 may also be used to advantage. Referring simultaneously to FIGS. 1 and 3, each cyclone 118 in the array is connected to the air duct 114 by a tangential inlet 124. The inlets 124 are adapted to carry incoming air from the duct 114 to the sample separation section 106. Each cyclone 118 is adapted to separate airborne particles from the primary air flow. A vortex finder 154 positioned proximate to the first ends 107 of the cyclones 118 comprises a plurality of short channels that project into the cyclones 118 to establish first exits ports 122 for the primary flow. That is, a first exit port 122 at the first end 107 of each cyclone 118 is adapted to collimate and guide the primary flow out of the cyclones 118, so that the primary flow may be discharged from the separation section 106. A second exit port 126 located proximate a second end 109 of each cyclone 118 carries the separated particle flow to the vortex breaker 120.

Referring to FIGS. 1, 2 and 4, the vortex breaker 120 is located proximate the second ends 109 of the cyclones 118 and in one embodiment comprises a series of chambers 128. One chamber 128 is positioned adjacent the second end 109 of each cyclone 118 and has an interior volume adapted to concentrate the particle flow carried from the cyclones 118 into a relatively denser, low velocity flow. Alternatively, one chamber (not shown) may be substantially annular in shape and be adapted to receive aerosol flow from all cyclones 118. A tangential slot 136 in a wall 138 of the vortex chamber 128 allows the aerosol flow to be drawn out of the chamber 128 and toward the capture section 108.

The vortex breaker 120 is separated from the capture section 108 by a controllable air/fluid boundary 130. The air/fluid boundary 130 is positioned adjacent the exterior of the vortex chambers 128, and in one embodiment the mechanism comprises a liquid plate 132 having a high porosity hydrophobic membrane 134 disposed thereon. The hydrophobic membrane 134 is adapted to establish a liquid seal or boundary between the vortex chamber 128, which is adapted to contain air or particle flow (i.e., a gaseous medium), and the capture section 108, which is adapted to contain a liquid as described further herein. In one embodiment, the membrane 134 comprises a nylon mesh that is thermally imbedded over at least a portion of the capture section 108. The nylon mesh is optionally treated with polytetrafluoroethylene (PTFE) or an equivalent substance to increase its hydrophobic properties.

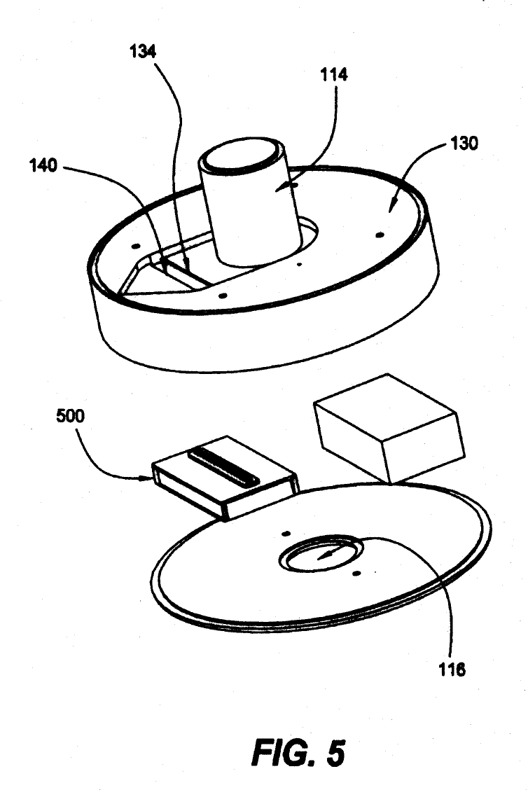

Referring to FIGS. 1 and 5, the capture section 108 comprises at least one microfluidie, or nanofluidic, channel 140 within which a small volume of liquid is contained for transporting the aerosol or other particles that have been focused therein. In one embodiment, a nylon mesh such as that described above is thermally embedded over the at least one channel 140. The capture section 108 may additionally comprise a liquid collection chamber 142, where the liquid flow (including the particles focused therein) is collected, or may alternatively be coupled to a means for transporting the flow to a separate analysis or collection device (not shown).

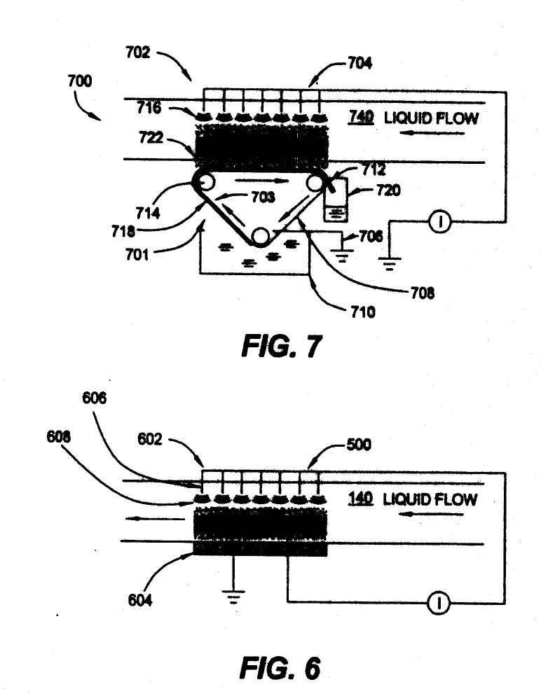

The air/fluid boundary 130 described above optionally includes an electrostatic focusing mechanism such as a corona charging section 500 for electrostatically manipulating the particles to enhance the focusing of the particles into the liquid in the at least one channel 140 of the capture section 108. As used herein, the term “corona” refers to the ionization of air between two electrodes occurring at or near atmospheric pressure. As airborne particles become charged within a corona charging section, they become attracted to the ground potential that is maintained on a collection device, such as a collection apparatus. One embodiment of a corona charging section 500 is illustrated in a schematic view in FIG. 6. The corona charging section 500 comprises a corona array 602 and a ground electrode 604. The corona array 602 comprises a plurality of corona tips 606 positioned proximate to the at least one channel 140 of the capture zone 108. The electrode 604 is positioned a distance away from the array, and in one embodiment is positioned across the channel 140 from the array 602. An electrostatic field 608 is thereby generated between the array 602 and the electrode 604. The electrostatic field 608 charges the particles in the liquid flow and drives them toward the middle of the channel 140. The corona charging section 500 is thereby adapted to enhance the manipulation of the particles into the liquid by urging the particles into the center of the liquid flow for quicker and more efficient transport. The electrostatic field generated by the corona charging section 500 also ensures a substantially uniformly charged particle stream.

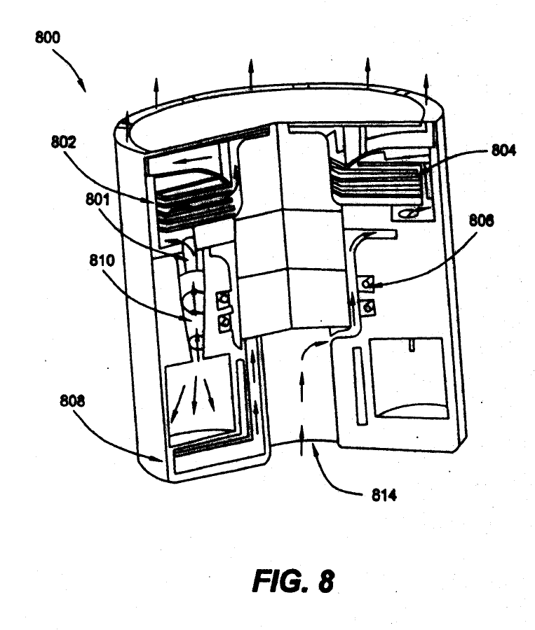

FIG. 7 is a schematic view of a second embodiment of a collection section 700 including a corona charging section 702. In this embodiment, the collection section 700 includes a corona array 704 and electrode 706, a translating particle-collecting material such as a tape 708, a reservoir 710 and a particle removal device 712. In one embodiment, the collection tape 708 has a first surface 701 and a second surface 703, and is adapted to translate around several bearings 714 (e.g., three or more) in a closed loop. In one embodiment, the closed loop resembles a triangle. The corona array 704 and electrode 706 generate an electrostatic field 716 that drives particles through an aperture 722 in the channel 740 and onto the adjacent first surface 701 of the collection tape 708. The reservoir 710 is positioned adjacent the lower bearing or bearings 714 and is adapted to wick a thin layer 718 of fluid onto a first surface 701 of the tape 708 as it translates past or through the reservoir 710. The liquid layer 718 enhances collection of aerosol particles on the tape surface 701. The particle removal device 712 is positioned to remove particles from tape 708 after particles have been deposited, but before the tape 708 translates past the reservoir 710. The collection device 712 may be a squeegee, a blade, a vacuum or any other device that is capable of removing the liquid layer 718 from the tape 708 so that the liquid and particles therein are transferred to a collection chamber 720. Optionally the first surface 701 of the tape 708 is treated to become hydrophilic, and the second surface 703 is treated to become hydrophobic. The area of the collection tape 708 may be very small to enable higher concentration of particles.

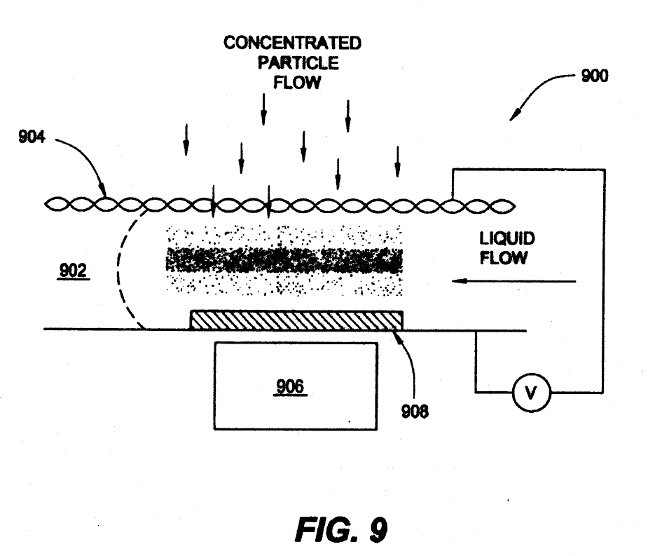

FIG. 9 is a schematic illustration of a third embodiment of a capture section 900 according to the present invention. The capture section 900 comprises a channel 902, a hydrophobic membrane 904, an electrostatic focusing electrode 906 and an electrophoretic electrode 908. The hydrophobic membrane 904 is substantially similar to that described previously herein, but is additionally made to be conductive and is embedded over a portion of the channel 902 adjacent the vortex breaker section (not shown). The electrophoretic electrode 908 is positioned across the channel 902 from the hydrophobic membrane 904. The electrostatic focusing electrode 906 is positioned outside of the channel 902, proximate the side on which the electrophoretic electrode 908 is positioned. A differential voltage V is applied across the channel 902 to create an electrophoretic pumping cell within the channel 902, between the hydrophobic membrane 904 and the electrophoretic electrode 908. An electrostatic effect created by the electrostatic focusing electrode 906 enhances the particle manipulation through the hydrophobic membrane 904 and into the liquid flow. The electrophoretic effect created by the pumping cell charges the particles in the liquid flow and drives them toward the center of the liquid flow for quicker and more efficient transport. In the event that there is interference between the electrostatic and electrophoretic effects, the two competing effects can be operated in a cyclic manner at an established optimum frequency that allows efficient electrostatic transport in the particle flow and also allows electrophoretic transport of the particles in the liquid flow.

FIG. 8 illustrates another embodiment of the present invention, in which a collection apparatus 800 also includes an electrostatic precipitator section 802. In one embodiment, the electrostatic precipitator section 802 comprises a plurality of precipitator plates 804 and at least one corona electrode 806, both located proximate the entries 801 (i.e., the first ends) of the cyclones 810. The electrostatic precipitator section 802 is adapted to attract small charged particles (i.e., charged within the cyclones 810 by the at least one corona electrode 806) that escape from the cyclones 810 along with the exiting primary flow rather than pass to the capture section 808.

Referring back to FIG. 1, in operation, the intake assembly 104 is activated to draw air into the apparatus 100 through the air duct 114. The air passes through the duct 114 to the tangential inlets 124, which carry the air flow to the cyclones 118.

The cyclones 118 separate particles from the primary air flow. As the flow field is rapidly revolved within the cyclone 118, centrifugal force drives the aerosol particles to the walls of the cyclone 118, where the particles may be tribo-charged by rubbing against the wall surface. As the flow continues to spiral through the cyclone 118 to the second end 109, additional particles are separated from the flow. The flow of aerosol particles exits the cyclones 118 through the second ends 109 and enters the chamber 128 of the vortex breaker 120, where it is concentrated into a denser, low velocity flow.

The primary flow reverses direction and flows back through the centers of the cyclones 118, where it passes out of the first ends 107 of the cyclones 118 and is carried past the fans 112A, 112B and through exhaust ports 144 in the first end 101 of the housing 102, to exit the collection apparatus 100. If a precipitator section such as that illustrated in FIG. 8 is incorporated, small charged particles that are not separated out of the primary flow by the cyclones 118 will be attracted to precipitator plates as the primary flow passes through the precipitator plates on the way to the exhaust ports 144. The use of an array of small cyclones 118 (rather than, for example, a single large cyclone) to separate the aerosol and primary flows provides improved separation efficiency at a low pressure drop, thereby enabling the construction of a quieter and more compact apparatus 100 that consumes less power. For example, in one embodiment, the entire apparatus 100 is only six inches in diameter.

The densified aerosol flow is drawn through the tangential slots 136 in the walls 138 of the vortex breaker chambers 128. As the particles flow outward from the chambers 128, the particles are electrostatically focused into an array of capillaries formed by the hydrophobic mesh membrane 134. The particles are drawn through the capillaries in the mesh 134 and into the liquid of the capture section 108, where a continuous liquid flow through the microfluidic channels 140 transports the captured particles into the collection chamber 142. Alternatively, the capture section 108 may be coupled to a port or line (not shown) that is adapted to transport the fluid out of the collection apparatus 100 and into, for example, a separate collection container or an analysis device.

As the flow of particles arrives at the air/liquid interface (i.e., the hydrophobic membrane 134), the particles reside in a boundary layer where the liquid flow velocity approaches zero. Particle transport in the liquid is enhanced by positioning the corona electrode (604 in FIG. 6) adjacent the collection chamber 142, but isolated from the collection liquid. In this manner, the electrostatic field 608 continues to act upon the particles after they have entered the collection liquid in the microfluidic channels 140 of the capture section 108, which urges the particles into the higher velocity flow in the central portions of the channels 140 so that the particles can be rapidly carried away. This positioning of the electrode 604 also alleviates the need to bias the liquid in the channels 140 to a high voltage to attract the aerosol particles. Other means for enhancing particle transport in the liquid include, but are not limited to, electro-kinetic pumping, pulsed pumping, ultrasonic techniques and incremental pumping.

Over the course of operation, the hydrophobic mesh membrane 134 may become clogged with large particles, dust or debris. In such an instance, the water in the channels 140 may be pressurized to a level exceeding the retention pressure of the mesh membrane 134. Consequently, the boundary established by the membrane 134 will be broken and water will flow out through the mesh 134, carrying dust and debris away with the flow. The water pressure is subsequently reduced, allowing the mesh membrane 134 to re-establish the liquid seal. Thus the hydrophobic membrane 134 may be easily cleaned without having to disassemble the collection apparatus 100.

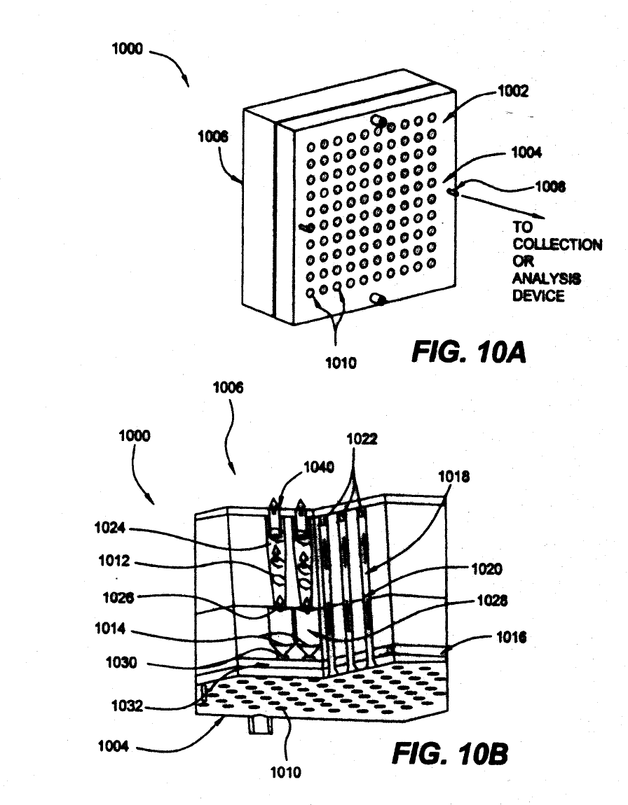

Although a collection apparatus according to the present invention has been heretofore described as a device having a substantially cylindrical configuration, those skilled in the art will appreciate that a collection apparatus may be constructed in alternate shapes and configurations without departing from the scope of the invention. In some embodiments, the collection apparatus of the present invention can be of a geometry that is substantially rectangular, substantially square or substantially circular. For example, FIGS. 10A-10B illustrate an embodiment of a collection apparatus 1000 having a substantially box-shaped housing 1002. In other embodiments, the collection apparatus can be a substantially flat plate, where the plate is substantially rectangular, square or circular.

The collection apparatus 1000 is constructed as a box having an air inlet side 1004 for the intake of air samples and an air outlet side 1006 opposite the inlet side 1004 for the expulsion of separated primary flow air. The inlet and outlet sides 1004, 1006 have a plurality of apertures 1010 for the intake or expulsion of air. In addition, at least one capture liquid outlet 1008 may be coupled to the housing 1002 to transport liquid and particles captured therein to a collection or analysis device (not shown).

As illustrated in FIG. 10B, the collection apparatus 1000 comprises an air intake section 1018, a separation section 1012, a vortex breaker section 1014 and a capture section 1016. The air intake section comprises a plurality of channels 1020 coupled to the apertures 1010 formed in the air inlet side 1004 of the housing 1002. Each channel 1020 has a tangential inlet 1022 that is coupled to the separation section 1012 for transporting air samples to the separation section 1012.

As in the previous embodiments, the separation section 1012 comprises at least one cyclone 1024 coupled to the inlets 1022 for receiving air samples and separating airborne particles in the samples from the primary flow. The at least one cyclone expels clean primary flow through a first exit port 1040, and expels separated particles through a second exit port 1026.

The second exit port 1026 transports the separated particles to a chamber 1028 of the vortex breaker section 1014, where the particle flow is concentrated for passage to the capture section 1016.

The capture section 1016 is coupled to the vortex breaker section 1014. Concentrated particle flow is passed through an exit port 1030 in the vortex chamber 1028 to a capture section channel 1032. The channel 1032 contains a liquid for transporting the particles to a collection or analysis device (i.e., via the capture liquid outlet 1008 illustrated in FIG. 10A). Electrostatic focusing mechanisms such as the hydrophobic mesh and/or corona biasing assembly discussed herein may be used to enhance particle manipulation in the channel 1032.

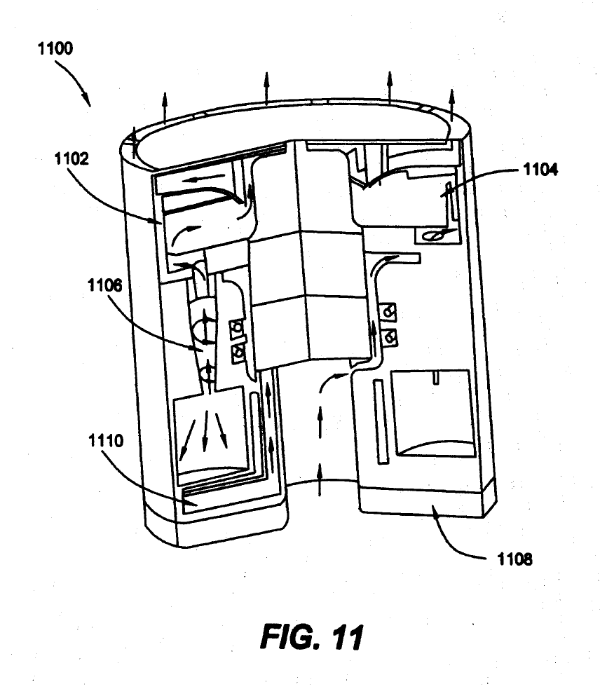

A fourth embodiment of a collection apparatus according to the present invention is illustrated in FIG. 11. The collection apparatus 1100 is substantially similar to the apparatus 800 illustrated in FIG. 8, but instead of an electrostatic precipitator section, the apparatus 1100 includes a condensation section 1102. In one embodiment, the condensation section 1102 comprises an evacuable volume 1104 that is adapted to cool and condense small airborne particles that escape from the cyclones 1106 along with the exiting primary flow. The condensation section 1102 may be adapted for coupling to an analysis or extraction device (not shown), for example by a port or connection that transports the condensed particles out of the apparatus 1100. Optionally, the apparatus 1100, or any of the alternate embodiments described herein, may include a detector section 1108 located adjacent to the capture section 1110 for retaining a device (not shown) to analyze the particles collected and condensed within the capture section 1110. The analysis device may be formed integral with the apparatus 1100, or the detector section 1108 may be manufactured for interface with a number of separate compatible analysis devices.

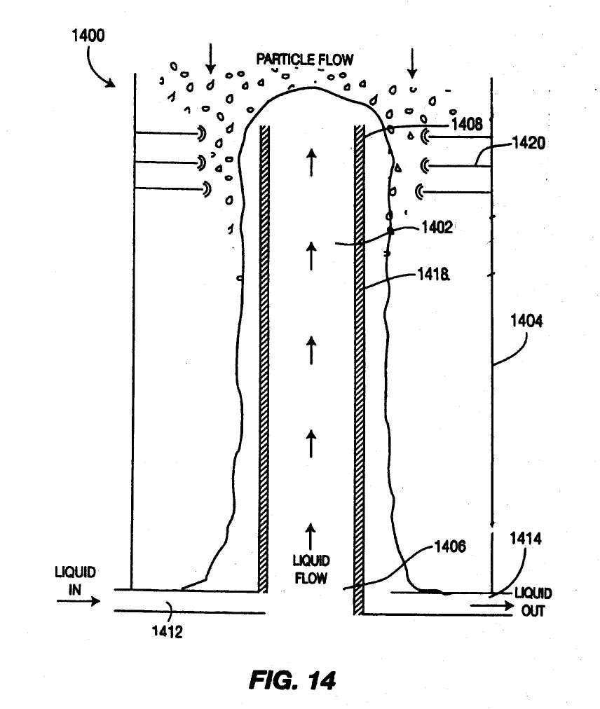

FIG. 14 is a schematic diagram illustrating a fifth embodiment of a particle collection system 1400 for depositing aerosol particles into a liquid, according to the present invention. The particle collection system 1400 may be implemented, for example, in place of the previously disclosed mechanisms (e.g., the sample separation and particle capture zones) for collecting and concentrating airborne particles into a liquid medium. However, the particle collection system 1400 may also be implemented in other forms of collection apparatuses as well (e.g., such as those without an inertial separator front end).

The particle collection system 1400 comprises a hollow tube 1402 coaxially disposed within the air duct 1404, which contains a flow of aerosol particles. The hollow tube 1402 is open at both a first end 1406 and an opposite second end 1408. In one embodiment, the hollow tube 1402 is comprised of at least one of: a sintered metal, a sintered glass and a sintered polymer.

In one embodiment of operation, a liquid is received near the first end 1406 of the hollow tube 1402 (e.g., via at least one inlet 1412 that is coupled to a reservoir or other liquid source, not shown) and pumped through the interior volume of the hollow tube 1402 toward the open second end 1408 of the hollow tube 1402. As the liquid approaches the open second end 1408 the hollow tube 1402, the liquid exits the hollow tube 1402 and spills over the second end 1408 of the hollow tube 1402 and along the outer surface of the hollow tube 1402. Thus, as evaporation occurs at the outer surface of the hollow tube 1402, more liquid is automatically delivered to the surface of the hollow tube 1402. Airborne particles from an incoming air sample within the air duct 1404 deposit in the liquid on the outer surface of the hollow tube 1402. The liquid, including the deposited particles, flows along the outer surface of the hollow tube 1402 to a particle collection or analysis device (e.g., via an outlet 1414 positioned near the outer surface of the hollow tube 1402).

In another embodiment of operation, airborne particles from an incoming air sample within the air duct 1404 deposit on a dry outer surface of the hollow tube 1402. The deposited particles are then “rinsed” from the outer surface of the hollow tube 1402 by pumping liquid through the hollow tube 1402 as described above.

Further embodiments of the particle collection system 1400 may be enhanced by providing a charging section comprising a first electrode 1418 at the surface of the hollow tube and at least one array 1420 of second electrodes (i.e., corona tips) proximate to the region in which the incoming air sample, including the particle flow, is received. In one embodiment, the first electrode 1418 comprises a thin (e.g., approximately 0.0005 to 0.002 inches thick) layer of conductive material (e.g., vapor deposited for sputtered metals such as tin, titanium or the like) disposed on the outer surface of the hollow tube 1402 (e.g., such that the outer surface of the hollow tube 1402 functions as a ground electrode). In another embodiment, the material that comprises the hollow tube 1402 may be a conductive or semiconductive material such as a sintered metal (e.g., stainless steel, titanium or the like) or a mixture of sintered polymer and sintered metal (e.g., a conductive plastic), such that the hollow tube 1402 itself functions as the first electrode 1418 (i.e., without a coating). In one embodiment, the array 1420 of corona tips is radially disposed, e.g., around an inner perimeter of the air duct 1404.

The array 1420 of corona tips, in cooperation with the first electrode 1418, generates an electrostatic field therebetween. When the array 1420 of corona tips is biased to a voltage that is sufficient to create a corona discharge, particles passing through the electrostatic field acquire charges due to field charging (i.e., in accordance with the Pauthenier equation). The trajectories of the charged particles are then influenced such that each particle has a high probability of depositing within the liquid on the outer surface of the hollow tube 1402 (e.g., the particles are deflected toward the first electrode 1418). In one embodiment, charging incoming particles achieves a collection efficiency of approximately ninety-nine percent or greater for particles of approximately 2 .mu.m in size, where collection efficiency is defined as the number of particles collected on the first electrode 1418 divided by the total number of incoming particles (e.g., as measured at the inlet of the air duct 1404). In further embodiments, additional arrays of corona tips may be implemented along the length of the air duct 1404, near points further along the length of the hollow tube 1402 (e.g., closer to the first end 1406 of the hollow tube 1402), to enhance deflection of particles along substantially the entire length of the hollow tube 1402.

The particle collection system 1400 thus combines a charging mechanism (e.g., the array 1420 of corona tips operating in conjunction with the first electrode 1418) with a collection mechanism (e.g., the hollow tube 1402) in order to achieve more efficient collection of airborne particles. Particles are thereby charged and collected in a single stage process (e.g., as opposed standard methods of charging particles in a first stage and depositing the particles onto a collection surface in a second stage). The implementation of the single-stage charging and collection mechanism substantially increases the quantity of airborne particles that are captured on the outer surface of the hollow tube 1402, thus providing better sample concentration for analysis than is currently achieved by existing collection devices.

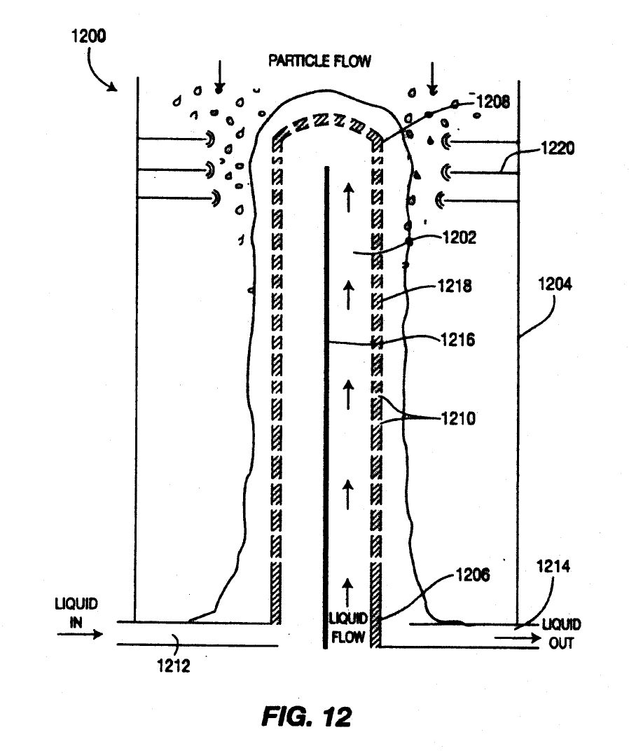

FIG. 12 is a schematic diagram illustrating a sixth embodiment of a particle collection system 1200 for depositing aerosol particles into a liquid, according to the present invention. Like the particle collection system 1400, the particle collection system 1200 may be implemented, for example, in place of the previously disclosed mechanisms (e.g., the sample separation and particle capture zones) for collecting and concentrating airborne particles into a liquid medium.

The particle collection system 1200 is substantially similar to the particle collection system 1400 and comprises a hollow tube 1202 coaxially disposed within the air duct 1204 of a particle collection apparatus. The hollow tube 1202 is open at a first end 1206 and closed at an opposite second end 1208. The hollow tube 1202 is comprised of a porous material that is capable of wicking liquid onto its surface. To that end, the hollow tube 1202 comprises a plurality of pores 1210. For example, in one embodiment, the hollow tube 1202 is comprised of at least one of a sintered glass and a sintered polymer.

In one embodiment of operation, a liquid is received near the open first end 1206 of the hollow tube 1202 (e.g., via at least one inlet 1212 that is coupled to a reservoir or other liquid source, not shown) and pumped through the interior volume of the hollow tube 1202 toward the closed second end 1208 of the hollow tube 1202. As the liquid is pumped through the hollow tube 1202, the liquid is drawn through the pores 1210 of the hollow tube 1202 and onto the outer surface of the hollow tube 1202 by capillary action. Thus, as evaporation occurs at the outer surface of the hollow tube 1202, more liquid is automatically delivered to the surface of the hollow tube 1202. Airborne particles from an incoming air sample within the air duct 1204 deposit in the liquid on the outer surface of the hollow tube 1202. The liquid, including the deposited particles, flows along the outer surface of the hollow tube 1202 to a particle collection or analysis device (e.g., via an outlet 1214 positioned near the outer surface of the hollow tube 1202).

In another embodiment of operation, airborne particles from an incoming air sample within the air duct 1204 deposit on a dry outer surface of the hollow tube 1202. The deposited particles are then “rinsed” from the outer surface of the hollow tube 1202 by pumping liquid through the hollow tube 1202 and out through the pores 1210 to the outlet 1214 as described above.

Similarly to the particle collection system 1400, further embodiments of the particle collection system 1200 may be enhanced by generating an electrostatic field that deflects incoming particles into the liquid on the outer surface of the hollow tube 1202. In one embodiment, this electrostatic field is generated by providing at least one array 1220 of corona tips proximate to the region in which the incoming air sample, including the particle flow, is received. The array 1220 of corona tips works in conjunction with a first electrode 1218 deposited on the outer surface of the hollow tube 1202 to deflect incoming particles into the liquid on the outer surface of the hollow tube 1202, as described above with reference to FIG. 14. In one embodiment, the array 1220 of corona tips is radially disposed, e.g., around an inner perimeter of the air duct 1204. In further embodiments, additional arrays of corona tips may be implemented near points further along the length of the hollow tube 1202 (e.g., closer to the first end 1206 of the hollow tube 1202) to enhance deflection of particles along substantially the entire length of the hollow tube 1202. In another embodiment, the porous material that comprises the hollow tube 1202 may be a conductive or semiconductive material such as a sintered metal (e.g., stainless steel, titanium or the like) or a mixture of sintered polymer and sintered metal (e.g., a conductive plastic), such that the hollow tube 1202 itself functions as the first electrode 1218 (i.e., without a coating).

In further embodiments, the hollow tube 1202 further comprises an electrokinetic pump for enhancing the flow of the liquid through the pores 1210 of the hollow tube 1202. The electrokinetic pump comprises a third electrode 1216 that is disposed coaxially within the hollow tube 1202, such that the third electrode is spaced apart from the first electrode by a dielectric (e.g., the hollow tube 1202 itself, which in this embodiment may be formed, for example, of a sintered glass or sintered polymer upon which the first electrode 1218 is deposited as a coating). The third electrode 1216 and the first electrode 1218 are of different potentials such that when an electric field between the third electrode 1216 and the first electrode 1218 is biased, an electrokinetically induced pressure deflects the liquid meniscus outwardly at the pores 1210 of the hollow tube 1202.

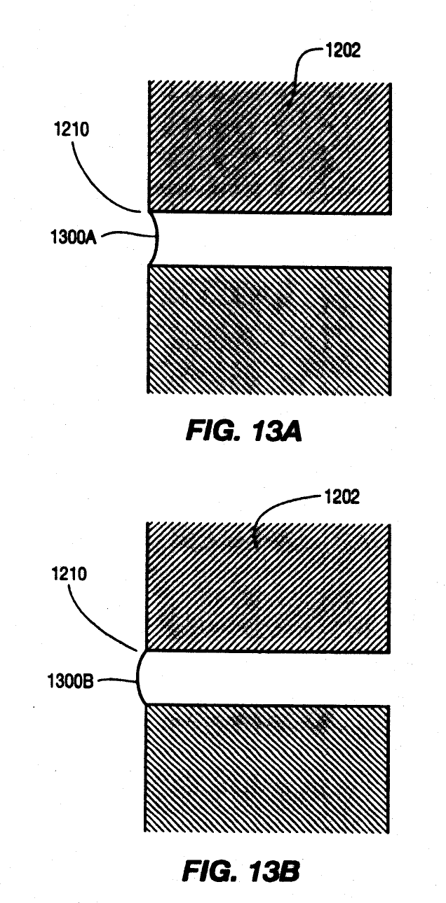

FIGS. 13A and 13B are schematic diagrams illustrating a typical pore 1210 of the hollow tube 1202. Specifically, FIG. 13A illustrates a pore 1210 absent the effects of electrokinetic pumping, while FIG. 13B illustrates the effects of electrokinetic pumping, as described above, applied to the same pore 1210. As illustrated, the effects of the electrokinetic pumping urge the meniscus 1300B of the liquid outwardly through the pore 1210, so that the outer surface of the hollow tube 1202 is substantially coated with at least a thin layer of liquid. In some embodiments, this may enhance the ability of the particle collection system 1200 to collect particles from an incoming air sample, as compared with an embodiment in which electrokinetic pumping is not applied (e.g., see the meniscus 1300A).

The location of the electrokinetic pump near the particle collection surface (e.g., the outer surface of the hollow tube 1202) provides several advantages. For example, such an arrangement facilitates liquid distribution in a multi-unit configuration. Additionally, the electrokinetic pump utilizes space that would normally remain unoccupied, and therefore requires no additional volume to achieve enhanced particle collection capabilities. Moreover, the configuration of the particle collection system 1200 including the electrokinetic pump is substantially orientation-independent and requires a minimal volume of liquid for collecting particles.

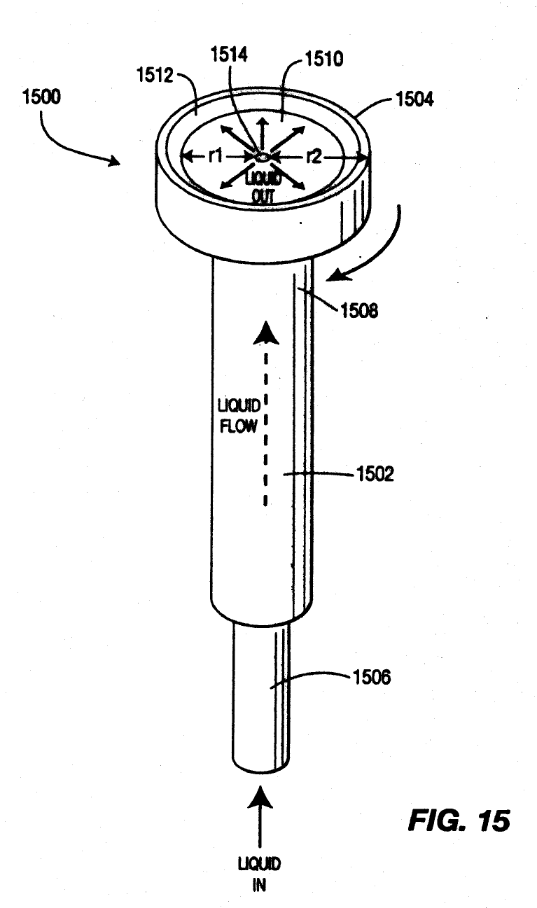

FIG. 15 is an isometric view illustrating a seventh embodiment of a particle collection system 1500 for depositing aerosol particles into a liquid, according to the present invention. Like the particle collection systems 1200 and 1400, the particle collection system 1500 may be implemented, for example, in place of the previously disclosed mechanisms (e.g., the sample separation and particle capture zones) for collecting and concentrating airborne particles into a liquid medium.

The particle collection system 1500 is similar in some ways to the particle collection systems 1200 and 1400 and comprises a hollow tube 1502 adapted to be coaxially disposed within the air duct of a particle collection apparatus. The hollow tube 1502 is open at both a first end 1506 and an opposite second end 1508.

In addition, the particle collection system 1500 comprises a rotatable disk 1504 positioned at the second end 1508 of the hollow tube 1502. The rotatable disk 1504 is positioned such that a rotational axis of the rotatable disk 1504 is orientated substantially coaxially with the longitudinal axis of the hollow tube 1502; thus, the rotatable disk 1504 is rotatable about the longitudinal axis of the hollow tube 1502.

The rotatable disk 1504 comprises a flat surface 1510 having a port 1514 disposed substantially in the center thereof and a first radius r.sub.1. The first radius r, is smaller than the radius r.sub.2 of the entire rotatable disk 1504, such that a trench 1512 is formed between the flat surface 1510 of the rotatable disk 1504 and the outer circumference of the rotatable disk 1504.

In one embodiment of operation, a liquid is received near the first end 1506 of the hollow tube 1502 (e.g., via at least one inlet that is coupled to a reservoir or other liquid source, not shown) and pumped through the interior volume of the hollow tube 1502 toward the second end 1508 of the hollow tube 1502. As the liquid is approaches the second end 1508 the hollow tube 1502, the liquid is exits the hollow tube 1502 through the port 1514 of the rotatable disk and spills over onto the flat surface 1510 of the rotatable disk 1504. Thus, as evaporation occurs at the flat surface 1510 of the rotatable disk 1504, more liquid is automatically delivered to the flat surface 1510 of the rotatable disk 1504. Airborne particles from an incoming air sample within the air duct deposit in the liquid on the flat surface 1510 of the rotatable disk 1504. As the rotatable disk 1504 rotates, the rotational motion causes the liquid, including the deposited particles, to be drawn away from the port 1514 and centrifugally pumped toward the trench 1512, where the liquid collects. The collected liquid, including the deposited particles, may then be siphoned, pumped or otherwise transported to a particle collection or analysis device (e.g., via an outlet, not shown, positioned near the trench 1512 or the outer surface of the hollow tube 1502).

In another embodiment of operation, airborne particles from an incoming air sample within the air duct deposit on a dry flat surface 1510 of the rotatable disk 1504. The deposited particles are then “rinsed” from the flat surface 15 10 of the rotatable disk 1504 by pumping liquid through the hollow tube 1502 and rotating the rotatable disk 1504 as described above.

Similarly to the particle collection systems 1200 and 1400, further embodiments of the particle collection system 1500 may be enhanced by providing at least one array of corona tips proximate to the region in which the incoming air sample, including the particle flow, is received. The array of corona tips works in conjunction with a first electrode deposited on the outer surface of the hollow tube 1502 to deflect incoming particles into the liquid on the flat surface 1510 of the rotatable disk 1504, as described above with reference to FIG. 14. In one embodiment, the array of corona tips is radially disposed, e.g., around an inner perimeter of the air duct.

In one embodiment, the rotatable disk 1504 is rotated at a high enough speed to render gravitational forces substantially insignificant. In such an embodiment, the particle collection system 1500 affords a greater degree of orientation capability for a particle collection device incorporating the particle collection system 1500, since gravity is not depended on to transport the liquid in which the particles are deposited.

In further embodiments, the rotatable disk 1504 may be substituted with a different mechanism such as a traveling tape or wire collections means that travels in and out of the air duct in a direction of motion that is substantially perpendicular to the airflow through the duct.

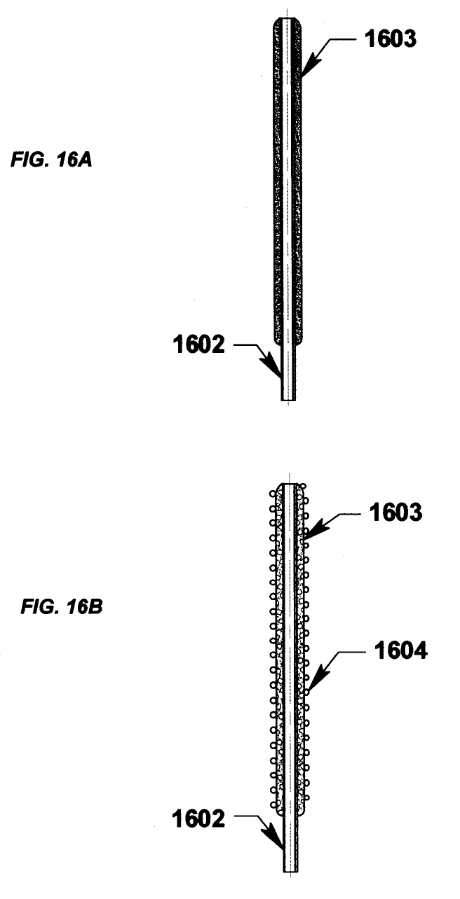

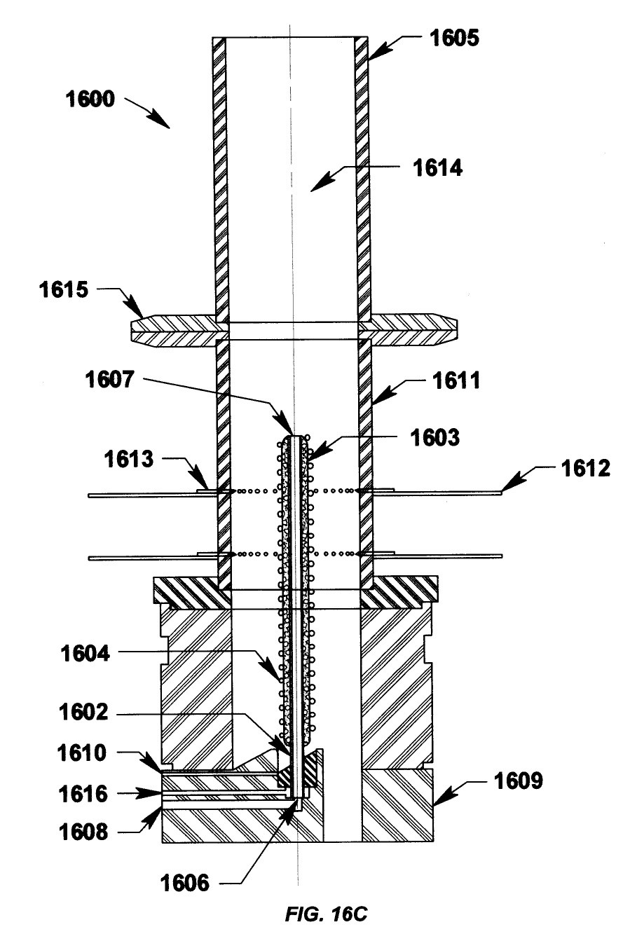

FIG. 16A is a schematic diagram illustrating another embodiment of a collection apparatus 1600 for collecting airborne particulate material and depositing aerosol particles into a liquid, according to the present invention. The collection apparatus 1600 may be implemented, for example, in place of the previously disclosed mechanisms (e.g., the sample separation and particle capture zones) for collecting and concentrating airborne particles into a liquid medium. However, the collection apparatus 1600 may also be implemented in other forms of collection apparatuses as well (e.g., such as those without an inertial separator front end).

The collection apparatus 1600 comprises a hollow tube 1602 comprising a material, which is wettable (i.e., capable of being wetted), having a volume resistivity of less than 10 Mohm-cm 1603 and optionally, an external feature 1604 that aids self-wetting of the collection apparatus 1600. See also, e.g., FIGS. 16B and 16C. The collection apparatus 1600 is a coaxially disposed within an air duct 1605, which contains a flow of aerosol particles. The hollow tube 1602 can be open at both a first end 1606 and an opposite second end 1607. In some embodiments, the hollow tube 1602 also comprises at least one material chosen from a conductive material and a semiconductive material, such as, a sintered metal (e.g., stainless steel, titanium, molybdenum, aluminum, copper, or the like, or a combination thereof, a ceramic, a sintered glass, and a mixture of sintered polymer and sintered metal (e.g., a conductive plastic). In some embodiments, the hollow tube 1602 comprises (1) at least one material chosen from a conductive material and a semiconductive material, and (2) a wettable material having a volume resistivity of less than 10 Mohm-cm 1603 coats the hollow tube 1602.

Suitable materials for use in the present invention that have a volume resistivity of less than 10 Mohm-cm include, for example and without limitation, cement, concrete, rock (i.e., a naturally occurring aggregate of at least one mineral, at least one mineraloid, or combination thereof. See also, U.S. Bureau of Mines Dictionary of Mining, Mineral, and Related Terms 1996), synthetic rock, and rock-like materials. As used herein, the phrase “synthetic rock” refers to materials that are non-naturally occurring that are wettable and have a volume resistivity of less than 10 Mohm-cm. As used herein, the phrase “rock-like materials” refers to naturally occurring materials that often are not considered to be rock, but which have wettability and a volume resistivity of less than 10 Mohm-cm.

Suitable cements for the present invention include, for example and without limitation, Portland cement, masonry cement, well cement, lightweight well cement, white cement, plastic cement (includes plasticizing agents), block cement, expansive cement, environmental cement (i.e., cement designed to limit the environmental impact of manufacture in comparison with traditional cements by reducing energy usage, virgin raw materials, atmospheric emissions, or a combination thereof), and blended cement (i.e., mixtures of Portland cement with other materials that either possess cementitious properties of their own, e.g. ground granulated iron blastfurnace slag and fly ash, or that are pozzolanic in nature, i.e. they react with lime in the presence of water to form cementitious compounds, e.g. fly ash and silica fume). (See also, e.g., P. C. Hewitt, Lea's Chemistry of Cement and Concrete, 4^{th} ed., Butterworth-Heinemann: Woburn, Mass., U.S.A. (2004), and F. W. Locher, Cement: Principles of production and use, Vbt Verlag Ban U. Technik: Duesseldorf, Germany (2005)). Additionally, the cement also can comprise a filler. The filler can be a material that is electrically conductive, for example and without limitation, carbon black, carbon fibers, steel or a combination thereof. The filler can be a material that is a self-wetting promoter of a liquid used in the operation of the collection system (e.g., a collection fluid); for example, and without limitation, titanium dioxide, treated glass, polymer beads, polymer fibers or the like. The filler can be a directional flow promoter of the liquid as a result of the filler in the cement being aligned for the flow during construction of the collection apparatus. An electrically-conductive filler can assist in the collection of the airborne particulate matter either in the capturing of the particles, acting as a self-wetting promoter of the liquid, or both.

Suitable external features (e.g., 1604) that allows self-wetting of a collection apparatus of the present invention (e.g. 1600) include, without limitation, a coil surrounding the collection apparatus, grooves (such as, radial and spiral) affixed to, etched into, or both, the exterior surface of the collection apparatus, channels vertically affixed to, etched into, or both, the exterior surface of the collection apparatus, a wiper positioned at any one end of the apparatus, a bubbler positioned atop the collection apparatus, and an adhesive applied geometrically to the exterior surface of the collection apparatus. As used herein, the term “bubbler” refers to a freely moving means that has a circular portion, such as a vane, radially positioned atop an arm portion. For example, the bubbler would be positioned atop the hollow tube 1602 of a collection apparatus 1600, where the circular portion is externally positioned to the apparatus while the arm portion extends downward into the hollow interior of the tube and thus, into the liquid. The arm first receives the liquid from the apparatus, which is then received by the circular portion, which slowly spins to distribute the fluid about a top end of the apparatus, thereby inducing flow down the entire exterior surface of the apparatus. As used herein, the term “wiper” refers to means that can be slid over the exterior surface of the apparatus. For example, where the apparatus is cylindrical (see FIGS. 16B-16C), the wiper can be a tube that slides over the apparatus where the volume between the tube inner diameter and the exterior surface of the apparatus would fill with the liquid, thereby causing the surface of the apparatus to wet substantially rapidly compared to wetting without the wiper.

The external feature that allows self-wetting of a collection apparatus of the present invention can be comprised of a substantially resistive material (i.e., substantially non-conductive). In some embodiments, the coil surrounding the collection apparatus comprises a plastic that is substantially resistive, such as, without limitation, a Nylon 6/6 stereolithography resin (e.g., a Selective Laser Sintering® (SLS®) powder (3-D Systems Corp., Rock Hill, S.C., USA; EOS GmbH, Munich, Germany) or a SLA® liquid resin (3-D Systems Corp., Rock Hill, S.C., USA)). In some embodiments, the grooves comprise a plastic that is substantially resistive, such as, without limitation, a Nylon 6/6 stereolithography resin. In some embodiments, the vertical channels comprise a plastic that is substantially resistive, such as, without limitation, a Nylon 6/6 stereolithography resin.

The external feature of the collection apparatus can operate actively or passively. A passive external feature would operate due to the force of the liquid supplied to the collection apparatus, while an active external feature would be powered (by human intervention or external power).

In some embodiments, the collection apparatus 1600 also comprises an internal feature that aids in self-wetting. Similar to the external feature described previously, the internal feature can be a coil, a plurality of channels, plurality of grooves, or a combination thereof. Such internal features can be affixed to, etched into, or both, the interior of the collection apparatus. Suitable materials for an internal feature are non-conductive materials such as resistive plastics.

In one embodiment of operation (see e.g., FIG. 16A), a liquid is received near the first end 1606 of the hollow tube 1602 (e.g., via at least one inlet 1608 of a collector base 1609 that is coupled to a reservoir or other liquid source, not shown) and under pressure (e.g., via a pump, not shown) flows up through the interior volume of the hollow tube 1602 toward the open second end 1607 of the hollow tube 1602. (The liquid, which can be referred to as the “collection fluid” or “collector fluid”, refers to a fluid that is conductive or semiconductive that is used to form a moving surface over the collection apparatus, such as, water, organic solvents and buffer solutions.) As the liquid approaches the open second end 1607 of the hollow tube 1602, the liquid exits the hollow tube 1602, first gathering at the top of the hollow tube 1602 with gravity then causing the liquid to spill over the second end 1607 of the hollow tube 1602 and along the exterior surface of the collection apparatus 1600.

In embodiments where the material that is wettable and having a volume resistivity of less than 10 Mohm-em is disposed 1603 on the hollow tube 1602, e.g., without limitation, as a coating, which comprises a material as previously described herein (as opposed to the hollow tube 1602 being made of the wettable material having a volume resistivity less than 10 Mohm-cm), the liquid spills along the coating. In embodiments where the wettable material having a volume resistivity of less than 10 Mohm-cm forms the hollow tube 1602 (as opposed to coating the hollow tube 1602), the liquid spills along the outer surface of the hollow tube 1602. As evaporation occurs at the exterior surface of the collection apparatus 1600, more liquid is automatically delivered to the second end of the hollow tube 1607, while because the wettable material having a volume resistivity of less than 10 Mohm-cm is inherently self-wetting, it rapidly becomes substantially completely wetted, thus resulting in the collection apparatus 1600 being substantially self-wetting. As used herein, the term “rapidly” or “rapid” refers to a rate of wetting of less than one minute for a hollow tube of ¼″(6.35 mm) outer diameter by 3.1″ (79 mm).

Next, airborne particles from air can be drawn into the air duct 1605 by means such as a fan (not shown), mounted to collector base 1609. The airborne particles of the incoming air within the air duct 1605 deposit in the liquid on the outer surface of the hollow tube 1602, as described above, which is the collection surface of the collection apparatus 1600. The liquid, including the deposited particles, flows along the outer surface of the hollow tube 1602 to the collector base 1609 and can be removed therefrom (e.g., via an outlet 1610 of the collector base 1609, which often is positioned near the outer surface of the hollow tube 1602, using vacuum) for subsequent analysis. The fluid removed can be collected manually or automatically and subsequently analyzed manually or automatically.

In embodiments of operation wherein the optional external feature 1604 that aids self-wetting of the collection apparatus 1600 is present. The external feature 1604 aids in the distribution of the liquid along the exterior surface of the collection apparatus 1600. In embodiments comprising a coil as the external feature 1604, the coil causes the liquid to distribute along the exterior surface by causing the liquid to cascade downward in a helical fashion, thereby, ensuring that the exterior surface of the collection apparatus 1600 is substantially wetted by the liquid substantially rapidly and substantially non-preferentially.

In another embodiment of operation, airborne particles from incoming air within the air duct 1605 deposit on a dry outer surface of the hollow tube 1602, as described above, which is the collection surface of the collection apparatus 1600. The deposited particles are then removed from the outer surface of the hollow tube 1602 by pumping liquid through the hollow tube 1602, as described above.

Further embodiments of the collection apparatus 1600 can be enhanced by providing a charging section, such as a corona head assembly 1611, comprising circuit boards 1612 and at least one array electrodes (i.e., corona tips) 1613 proximate to the region in which the incoming air sample, including the particle flow, is received 1614. In FIG. 16A, the corona head assembly 1611 is connected to the air inlet region 1614 by a connector means 1615, such as a clamping device. In one embodiment, the array of corona tips 1613 is radially disposed around the corona head assembly 1611. In one embodiment, the array of corona tips 1613 is radially disposed, e.g., around an inner perimeter of the air duct 1605. In some embodiments, the array of corona tips 1613, in cooperation with the hollow tube 1602 via an electrical conductor (not shown) that extends through an electrical connection port 1616 housed in the collector base 1609 and is connected to the first end 1606 of the hollow tube 1602, generates an electrostatic field therebetween. When the array of corona tips 1613 is biased to a voltage that is sufficient to create a corona discharge, particles passing through the electrostatic field acquire charges due to field charging (i.e., in accordance with the Pauthenier equation). In some embodiments, the electrostatic field is generated by use of high voltage power, such as DC electrical power of >5 kilovolts (kV). The trajectories of the charged particles are then influenced such that each particle has a high probability of depositing within the liquid on the outer surface of the hollow tube 1602 (e.g., the particles are deflected toward the hollow tube 1602). In one embodiment, charging incoming particles achieves a collection efficiency of approximately ninety-nine percent or greater for particles of approximately 2 μm in size, where collection efficiency is defined as the number of particles collected on the hollow tube 1602 divided by the total number of incoming particles (eg., as measured at the inlet of the air duct 1605). In further embodiments, additional arrays of corona tips can be implemented along the length of the air duct 1605, near points further along the length of the hollow tube 1602 (e.g., closer to the first end 1606 of the hollow tube 1602), or both, to enhance deflection of particles along substantially the entire length of the hollow tube 1602.

In some such embodiments, the collection apparatus 1600, thus combines a charging mechanism (e.g., the array of corona tips 1613 operating in conjunction with the a first electrode (e.g., the hollow tube 1602) with a collection mechanism (e.g., the material that is wettable with a resistivity less than 10 Mohn-cm disposed on the hollow tube 1603) in order to achieve more efficient collection of airborne particles; thereby, resulting in particles being charged and collected in a single stage process (e.g., as opposed to two stage methods of charging particles in a first stage and depositing the particles onto a collection surface in a second stage). The implementation of the single-stage charging and collection mechanism substantially increases the quantity of airborne particles that are captured on the outer surface of the collection apparatus 1600, thus providing better sample concentration for analysis than achieved by two-stage collection devices.

In further embodiments of the collection apparatus 1600, the hollow tube 1602 is open at a first end 1606 and closed at an opposite second end 1607. The hollow tube 1602 is comprised of a porous material that is capable of wicking liquid onto its surface. To that end, the hollow tube 1602 comprises a plurality of pores. In one embodiment of operation of such a collection apparatus 1600, a liquid is received near the open first end 1606 of the hollow tube 1602 and pumped through the interior volume of the hollow tube 1602 toward the closed second end 1607 of the hollow tube 1602. As the liquid is pumped through the hollow tube 1602, the liquid is drawn through the pores of the hollow tube 1602 and onto the outer surface of the hollow tube 1602 by capillary action. Thus, as evaporation occurs at the outer surface of the hollow tube 1602, more liquid is automatically delivered to the surface of the hollow tube 1602. Where the hollow tube is comprised solely of a wettable material having a resistivity of less than 10 Mohm-cm, the outer surface of the hollow tube 1602 is the exterior surface of the collection apparatus 1600. Airborne particles from an incoming air sample within the air duct 1605 deposit in the liquid on the outer surface of the hollow tube 1602 (i.e., the exterior surface of the collection apparatus 1600). The liquid, including the deposited particles, flows along the outer surface of the hollow tube 1602 to the collector base 1609 and can be removed therefrom (e.g., via an outlet 1610 of the collector base 1609, which often is positioned near the outer surface of the collection apparatus 1600, using vacuum) for subsequent analysis. The fluid removed can be collected manually or automatically and subsequently analyzed manually or automatically.

In such further embodiments of the collection apparatus 1600, where the hollow tube is comprised of a conductive material or semiconductive material with a coating of a wettable material having a resistivity of less than 10 Mohm-cm, the outer surface of the coating is the exterior surface of the collection apparatus 1600. In one embodiment of operation of a collection apparatus 1600 In such embodiments, the liquid is drawn from the outer surface of the hollow tube 1602 to the interior surface of the coating and then inherently moves towards the outer surface of the coating, i.e., the exterior surface of the collection apparatus 1600, since of the coating is inherently self-wetting. Thus, airborne particles from an incoming air sample within the air duct 1605 deposit in the liquid on the outer surface of the hollow tube 1602 (i.e., the exterior surface of the collection apparatus 1600). The liquid, including the deposited particles, flows along the outer surface of the coating 1603 to the collector base 1609 and can be removed therefrom (e.g., via an outlet 1610 of the collector base 1609, which often is positioned near the outer surface of the ucollection apparatus 1600, using vacuum) for subsequent analysis. The fluid removed can be collected manually or automatically and subsequently analyzed manually or automatically.

In some embodiments, the collection apparatus 1600 of the present invention comprises a geometry that is substantially rectangular, substantially square or substantially circular, as opposed to substantially cylindrical as exemplified in FIGS. 16A-16C. For example, the collection apparatus can be a substantially flat plate, where the plate is substantially rectangular, square or circular. Some such embodiments can be used for air purification where, e.g., the surface area for collection can be increased to accommodate higher air flows needed for air purification as compared to air analysis.

Further embodiments of the collection apparatus and the collection systems of the present invention can comprise any element or combination of elements from any embodiment exemplified herein and no element described herein is limited to the embodiment with which it has been described.

It must be noted that, as used herein and in the appended claims, the singular forms “a”, “and”, and “the” include plural references, unless the context clearly dictates otherwise. All publications mentioned herein are incorporated herein by reference to disclose and described the methods and/or materials in connection with which the publications are cited.

### EXAMPLES

The following examples are put forth so as to provide those of ordinary skill in the art with a complete disclosure and description of the present invention, and are not intended to limit the scope of the invention nor is it intended to represent that the experiments below are the only experiment performed.

### Example 1

### Self-Wetting Collection Apparatus

The following example exemplifies the preparation of a self-wetting apparatus as illustrated in FIGS: 16A-16B.

Mold. A mold was made from Delrin®, such as of a standard, unreinforced general purpose grade (DuPont Engineering Polymers, Wilmington, Del.). The mold for preparation of a cylindrical collection apparatus: ¼″ (6.35 mm) outer diameter by 3.1″ (79 mm) long with a circumference of 0.785″ (19.9 mm). The mold comprised a body of two halves and a cap. The overall dimensions of the mold were ⅘″(114/3) long, 2″ (50.8 mm) wide and 1.5″ (38.1 mm) deep. The mold had four outer screw holes, four head screw holes and jack-holes on the inside of each halve for breaking apart the halves after forming the collection apparatus. Four 1 inch 6-32 socket head screws were used to join the two halves of the mold, while four ¾ inch 6-32 socket head screws were used as the mold caps. A ½ inch 0.091 OD (outer diameter) stainless steel rod was used as the interior metal tip of the mold.

Preparation of metal tubing. Stainless steel (SS) tubing of 0.12 inch OD and 0.094 inch ID (inner diameter) (#8988K447 from McMaster-Carr Supply Company, New Brunswick, N.J.) was cut into 3.5 inch tubes. The ends of the SS tubes were sanded and reamed, and the openings at the ends were checked to make sure that they were large enough to fit the metal tip of the mold.

Preparation of cement. Twenty grams of Portland cement were crushed into a fine powder as possible. The crushed Portland cement was placed in a disposable cup and mixed with 7 mL of water. The cement mixture was made to a paste-like consistency. Proportions of crushed cement and water were adjusted accordingly.

Preparation of Collection Apparatus The cement mixture was poured into each half of the mold, breaking up any chunks or hard spots in the cement mixture. The upper surface of the cement mixture was smoothed using a dowel and small wooden stick so that it was flush with the upper surface of the mold. The metal tip of the mold was inserted into one end of a 3.5 inch tube, leaving enough of the metal tip exposed so that it could sit in a groove in the mold. The metal tip was aligned with the groove and the 3.5 inch SS tube was pushed into the cement mixture filling one half of the mold. Excess cement mixture that built up around the SS tube was removed. The two halves of the mold (one containing the SS tube embedded in the cement mixture and the other containing only cement mixture) were pressed together. The four 1 inch 6-32 socket head screws were screwed into the four outer screw holes to seal the two halves together. Excess cement mixture that formed around the portion of the SS tube extruding from the mold was removed. The cap of the mold was place over the portion of extruding SS tube, pressed down onto the mold and sealed to the mold with the four ¾ inch 6-32 socket head screws.

Next, the mold with the extruding SS tube portion point upward was shaken for 10 seconds on a Fisher Vortex-Geniet® G560 (Scientific Industries, Inc., Bohemia, N.Y.). Using a long metal rod, the mold tip was tapped to make sure it had not risen inside of the SS tube.

The mold was allowed to sit undisturbed for at least two days to allow the cement mixture to cure.

After curing, the mold was opened by separating the two halves. The four ¾ inch 6-32 socket head screws were unscrewed from the mold's cap, and then the cap was pulled off so as not to pull on the SS tube. The four 1 inch 6-32 socket head screws were unscrewed from the body of the mold. Four 6-32 socket head jack-up screws were slowly screwed into four jack-up holes, alternating between screws, while the mold halves were kept parallel to reduce the occurrence of the cement cracking. The upper half of the mold was removed. The tip of the cement coating was pushed to slide out the cement coated SS tube (i.e., collection apparatus) from the lower mold half. (If the collection apparatus does not slide out, the metal tube can be slowly lifted until the coated tube lifts out of the mold.)

### Example 2

### Operation of a Self-Wetting Collection System

The following example exemplifies operating in normal mode a self-wetting particle collection system as illustrated in FIG. 16A.

The collection system was assembled as shown in FIG. 16A with a collection apparatus prepared as described in Example 1. The collection apparatus further comprised a plastic coil (Nylon 6/6 stereolithography resin), which surrounded the cement coating of the apparatus, to aid in the wetting efficiency of the apparatus.

A fluid pump was initiated and the post allowed to wet with deionized water, as describe hereinabove. Then the fan was started to draw air through the wet collector, as describe hereinabove. Finally, the high voltage circuit was empowered to generate a corona field within the collection system, as describe hereinabove. Observations were made to ensure that no high voltage arcing occurred. This test demonstrated that a collection apparatus of a cement post construction was indeed viable.

### Example 3

### Smoke Testing of a Self-Wetting Collection System

The following example exemplifies testing the operation of a self-wetting particle collection system as illustrated in FIG. 16A by use of a smoke test to ensure that particulate capture was indeed taking place within the collection system. The collection system was assembled as shown in FIG. 16A with a collection apparatus prepared as described in Example 1. The collection apparatus further comprised a plastic coil (Nylon 6/6 stereolithography resin), which surrounded the cement coating of the apparatus, to aid in the wetting efficiency of the apparatus.

The smoke test was carried out by starting up the wet collector, allowing the collection apparatus (cement post) to wet, initiating air flow by starting the fan motor, and initiating the high voltage corona field, as described hereinabove. Smoke, from a burning incense stick, was then introduced near the air inlet of the collection system. The smoke was drawn through the collection system due to air movement provided by the fan. The smoke filled air was then exposed to the high voltage field and the smoke particles were drawn to the cement post where they were captured in the opposite charged field of the water wetted cement post. The water recovered from this test was discolored and evidenced that smoke particles were indeed captured by the self-wetting collection system having a self-wetting collection apparatus comprised of cement. There was substantially less smoke exiting the self-wetting collection system than entering it, which demonstrated that the system was doing a good job of extracting the smoke particulate matter.

Thus, the present invention represents a significant advancement in the field of aerosol collection, including without limitation, bio-aerosol collection. An apparatus is provided that achieves highly efficient collection of airborne particles into a small volume of liquid, which may be easily analyzed for the detection of pathogenic, chemical and other undesirable particles, or a combination thereof. The efficiency of the apparatus is belied by the compact dimensions of the apparatus, which enable the apparatus to be easily incorporated in portable particle collection devices. Moreover, the orientation-independent configuration of the apparatus makes the apparatus suitable for use in a variety of environments and devices.

While the foregoing is directed to embodiments of the invention, other and further embodiments of the invention may be devised without departing from the basic scope thereof and the scope thereof is determined by the claims that follow.

What is claimed is:

1) An apparatus for collecting airborne particles from air comprising a material with a volume resistivity less than about 10 Mohm-cm, wherein the apparatus is adapted for receiving a liquid.

2) The apparatus of claim 1, wherein the material is selected from a group consisting of cement, concrete, rock, synthetic rock, and rock-like material.

3) The apparatus of claim 2, wherein the cement is selected from a group consisting of Portland cement, masonry cement, well cement, lightweight well cement, white cement, plastic cement, block cement, expansive cement, environmental cement, and blended cement.

4) The apparatus of claim 3, wherein the cement further comprises a filler.

5) The apparatus of claim 4, wherein the filler is an electrically conductive material.

6) The apparatus of claim 4, wherein the filler is a material that is a self-wetting promoter of the liquid.

7) The apparatus of claim 6, wherein the material that is a self-wetting promoter is selected from the group consisting of titanium dioxide, treated glass, polymer beads, and polymer fibers.

8) The apparatus of claim 4, wherein the filler is a directional flow promoter of the liquid as a result of the filler in the cement being aligned for flow during construction of the apparatus.

9) The apparatus of claim 1, farther comprising at least one conductive material or semiconductive material.

10) The apparatus of claim 9, wherein the at least one conductive material or semiconductive material is selected from the group consisting of a metal, a sintered metal, a conductive ceramic, a sintered glass, and a mixture of sintered polymer and sintered metal.

11) The apparatus of claim 10, wherein the metal or the sintered metal is selected from a group consisting of stainless steel, titanium, molybdenum, aluminum, copper, sintered stainless steel, sintered titanium, sintered molybdenum, sintered aluminum, sintered copper, or a combination thereof.

12) The apparatus of claim 10, wherein the mixture of sintered polymer and sintered metal comprises a conductive plastic.

13) The apparatus of claim 9, wherein the material with a volume resistivity less than about 10 Mohrn-cm coats the at least one conductive material or semiconductive material.

14) The apparatus of claim 1, further comprising an external feature that aids in self-wetting of the apparatus, wherein the external feature is selected from a group consisting of a coil, a plurality of grooves, a plurality of channels, a bubbler, a wiper, and an adhesive, wherein:
a) if the external feature is the coil, the coil surrounds the apparatus;
b) if the external feature is the plurality of grooves, the grooves are affixed to, etched into, or both, the exterior surface of the apparatus;
c) if the external feature is the plurality of channels, the channels are vertically affixed to, vertically etched into, or both, the exterior surface of the apparatus;
d) if the external feature is the bubbler, the bubbler is positioned atop the apparatus;
e) if the external feature is the wiper, the wiper is positioned at an end of the apparatus; and
f) if the external feature is the adhesive, the adhesive is applied geometrically to the exterior surface of the apparatus.

15) The apparatus of claim 14, wherein the external feature comprises a substantially resistive material.

16) The apparatus of claim 15, wherein the substantially resistive material is a non-conductive plastic.

17) The apparatus of claim 16, wherein the non-conductive plastic is a Nylon 6/6 stereolithography resin.

18) The apparatus of claim 1, further comprising an internal feature that aids in self-wetting of the apparatus, wherein the internal feature is selected from a group consisting of a coil, a plurality of grooves, and a plurality of channels and the internal feature is affixed to, etched into, or both, the interior surface of the apparatus.

19) The apparatus of claim 1, wherein the apparatus comprises a geometry selected from the group consisting of cylindrical, rectangular, square or circular.

20) The apparatus of claim 19, wherein the geometry is selected from a group consisting of substantially tubular and substantially flat.

21) An apparatus for collecting airborne particles from air comprising a hollow tube adapted for receiving a liquid through an interior volume of the hollow tube and for delivering that liquid to an outer surface of the hollow tube, wherein the hollow tube comprises a material with a volume resistivity less than about 10 Mohm-cm.

22) The apparatus of claim 21, wherein the hollow tube further comprise at least one conductive material or semiconductive material.

23) The apparatus of claim 22, wherein the material with a volume resistivity less than about 10 Mohm-cm coats the at least one conductive material or semiconductive material.

24) The apparatus of claim 23, further comprising an external feature that aids wetting of the apparatus, wherein the external feature is selected from a group consisting of a coil, a plurality of grooves, a plurality of channels, a bubbler, a wiper, and an adhesive, wherein:
a) if the external feature is the coil, the coil surrounds the apparatus;
b) if the external feature is the plurality of grooves, the grooves are affixed to, etched into, or both, the exterior surface of the apparatus;
c) if the external feature is the plurality of channels, the channels are vertically affixed to, vertically etched into, or both, the exterior surface of the apparatus;
d) if the external feature is the bubbler, the bubbler is positioned atop the apparatus;
e) if the external feature is the wiper, the wiper is positioned at an end of the apparatus; and
f) if the external feature is the adhesive, the adhesive is applied geometrically to the exterior surface of the apparatus.

25) An apparatus for collecting airborne particles from air comprising:
a) a hollow tube adapted for receiving a liquid through an interior volume of the hollow tube and for delivering that liquid to an outer surface of the hollow tube; and
b) a collection surface disposed on the outer surface of the hollow tube and adapted for collecting the airborne particles from the air, wherein the collection surface comprises a material with a volume resistivity less than about 10 Mohm-cm.

26) The apparatus of claim 25, wherein the hollow tube comprises at least one conductive material or semiconductive material.

27) The apparatus of claim 26, wherein the material with a volume resistivity less than about 10 Mohm-cm coats the outer surface of the hollow tube.

28) The apparatus of claim 27, wherein the material is selected from a group consisting of cement, concrete, rock, synthetic rock, and rock-like material.

29) The apparatus of claim 28, wherein the cement is selected from a group consisting of Portland cement, masonry cement, well cement, lightweight well cement, white cement, plastic cement, block cement, expansive cement, environmental cement, and blended cement.

30) The apparatus of claim 29, wherein the cement is Portland cement.

31) The apparatus of claim 30, further comprising an external feature that aids wetting of the apparatus, wherein the external feature is selected from a group consisting of a coil, a plurality of grooves, a plurality of channels, a bubbler, a wiper, and an adhesive, wherein:
a) if the external feature is the coil, the coil surrounds the apparatus;
b) if the external feature is the plurality of grooves, the grooves are affixed to, etched into, or both, the exterior surface of the apparatus;
c) if the external feature is the plurality of channels, the channels are vertically affixed to, vertically etched into, or both, the exterior surface of the apparatus;
d) if the external feature is the bubbler, the bubbler is positioned atop the apparatus;
e) if the external feature is the wiper, the wiper is positioned at an end of the apparatus; and
f) if the external feature is the adhesive, the adhesive is applied geometrically to the exterior surface of the apparatus.

32) The apparatus of claim 31, further comprising a charging mechanism adapted for charging the airborne particles such that the airborne particles are deflected toward the apparatus.

33) A method for collecting airborne particles from air, said method comprising the steps of:
a) providing an air sample;
b) directing the air sample toward a collection apparatus of any of claims 1, 21, and 25; and
c) initiating operation of the collection apparatus,
wherein the airborne particles from the air are collected in a single stage.

34) The method of claim 33, wherein the collection apparatus further comprises a charging mechanism adapted for charging the airborne particles such that the airborne particles are deflected toward the apparatus.
